(19) United States
(12) Patent Application Publication
(10) Pub. No.: US 2010/0159916 A1
(43) Pub. Date: Jun. 24, 2010

(54) Reducing Radio Frequency Radiation Intensity Near Users of a Cellular Network

(76) Inventors: Oren EZER, Tel Aviv (IL); Aharon SHAER, Kfar Saba (IL); Pesach MELAMED, Hertzeliya (IL)

Correspondence Address: The Law Office of Michael E. Kondoudis, 888 16th Street, N.W., Suite 800, Washington, DC, 20006, US

(21) Appl. No.: 12/646,948

(22) Filed: Dec. 23, 2009

Related U.S. Application Data
(60) Provisional application No. 61/140,635, filed on Dec. 24, 2008.

(51) Int. Cl. H04W 99/00; H04B 7/00

(52) U.S. Cl. 455/422.1; 455/41.2

(57) ABSTRACT

A communication system, a mediator relay transceiver and a method for reducing cellular radiation intensity near users. A mediator relay transceiver is arranged to connect via an internal communication link to mobile communication device exhibiting short range communication capabilities and is connected via cellular communication links to cellular networks. User communication via the internal communication link replaces user communication via the cellular communication link and the mediator relay transceiver is arranged such that the radiation to the users via the internal communication link is of lower intensity than the radiation to the users via the cellular communication links.

### CROSS-REFERENCE TO RELATED APPLICATION

This application claims the benefit of U.S. Provisional Patent Application No. 61/140,635, filed Dec. 24, 2008, which is incorporated by reference.

### TECHNICAL FIELD

The present invention generally relates to the field of radiation protection. More particularly, the present invention relates to reducing cellular radiation to users.

### BACKGROUND OF THE RELATED ART

Prior to setting forth the background of the related art, it may be helpful to set forth the definition of the term “communication parameters” as used herein in this application. “Communication parameters” is defined as all parameters relating to communication such as bandwidth, level of service, availability of providers and transceivers, radiation from transceivers, price of communication, volume of communication and so forth.

Cellular phones are becoming ever more common, yet studies show increasing risks of exposure to the radiation emitted by the devices. Damages are mostly in the head area and to the central nervous system, including the brain. The intensity and frequency of damage are related to the frequency and duration of cellular phone conversations. Available solutions to this problem are wire or wireless earphones.

U.S. Patent Publication No. US2002/0085511, which is incorporated herein by reference in its entirety, discloses a method for communicating information between a first wireless communication device and a communications network via a particular second wireless communication device, the communications network being the second wireless communication device's own communications network.

WIPO Publication No. WO2007023490, which is incorporated herein by reference in its entirety, discloses a cellular communication system which comprises a cellphone interface unit that includes a transceiver for low power RF communication; a microphone; an earphone; a display; a keypad; a hub device that includes a transceiver for low power RF communication; an antenna for high power RF communication and circuitry and appropriate software components for establishing a communication channel between the hub and a base station.

### BRIEF SUMMARY

Embodiments of the present invention provide a communication system, a mediator relay transceiver and a method for reducing cellular radiation intensity near users. One communication system comprises at least one mobile communication device and at least one mediator relay transceiver. The at least one mobile communication device is associated with at least one user and exhibits short range communication capabilities as well as cellular communication capabilities. The at least one mediator relay transceiver is arranged to connect via an internal communication link to at least one mobile communication device and to connect via at least one cellular communication link to at least one main cell transceiver. The at least one main cell transceiver is connected to at least one cellular network. The internal communication link utilizes the short range communication capabilities exhibited by the at least one mobile communication device. The at least one mediator relay transceiver is connected to each of the at least one main cell transceiver via at least one corresponding cellular communication link. The at least one mediator relay transceiver is arranged to transmit and receive communication between the at least one mobile communication device and the at least one main cell transceiver. User communication via the internal communication link replaces user communication via the at least one cellular communication link to the at least one main cell transceiver. The at least one mediator relay transceiver is arranged such that the radiation to the at least one user via the internal communication link is of lower intensity than the radiation to the at least one user via the at least one cellular communication link.

One mediator relay transceiver comprises a cellular communication module, a short-range communication module, a user interface and an application. The cellular communication module exhibits cellular communication capabilities and is connected via at least one cellular communication link to at least one cellular network. The short-range communication module exhibits short range communication capabilities and is connected via an internal communication link to at least one mobile communication device associated with at least one user, wherein the at least one mobile communication device exhibits short range communication capabilities as well as cellular communication capabilities. The user interface arranged to present a status of the mediator relay transceiver and to enable inputting preferences. The application arranged to control the operation of the cellular communication module, the short-range communication module and the user interface. The at least one mediator relay transceiver is arranged to transmit and receive communication between the at least one mobile communication device and the at least one cellular network. The internal communication link utilizes the short range communication capabilities exhibited by the at least one mobile communication device. User communication via the internal communication link replaces user communication via the at least one cellular communication link to the at least one cellular network. The at least one mediator relay transceiver is arranged such that the radiation to the at least one user via the internal communication link is of lower intensity than the radiation to the at least one user via the at least one cellular communication link.

One method comprises the stages: (i) positioning at least one mediator relay transceiver; (ii) connecting the at least one mediator relay transceiver via an internal communication link to at least one mobile communication device of at least one user; (iii) connecting the at least one mediator relay transceiver via at least one cellular communication link to at least one main cell transceiver of at least one cellular network; and (iv) transmitting incoming and outgoing calls of the cellular network to the at least one user via the at least one mediator relay transceiver. Positioning at least one mediator relay transceiver is carried out such that the radiation to the user via the internal communication link is of lower intensity than the radiation to the user via the cellular communication link.

In embodiments, internal communication link may comprise Bluetooth. The mediator relay server may be installed outdoors or indoors.

### BRIEF DESCRIPTION OF THE DRAWINGS

For a better understanding of the invention and to show how the same may be carried into effect, reference will now be made, purely by way of example, to the accompanying drawings in which like numerals designate corresponding elements or sections throughout.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 is a block diagram illustrating a communication system for reducing cellular radiation intensity near users, according to some embodiments of the invention.

FIG. 2 is a block diagram illustrating a communication system for reducing cellular radiation intensity near users using cellular networks, according to some embodiments of the invention.

FIG. 3 is a block diagram illustrating a mediator relay transceiver for reducing cellular radiation intensity near users using cellular networks, according to some embodiments of the invention;

FIG. 4 is a flowchart illustrating a method of reducing cellular radiation intensity near at least one user using a cellular network, according to some embodiments of the invention; and

FIGS. 5A, 5B and 5C are flowcharts illustrating additional stages of the method of reducing cellular radiation intensity, according to some embodiments of the invention.

### DETAILED DESCRIPTIONS OF SOME EMBODIMENTS OF THE INVENTION

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting. In other instances, well-known methods, procedures, components and circuits have not been described in detail so as not to obscure the teachings of the present disclosure.

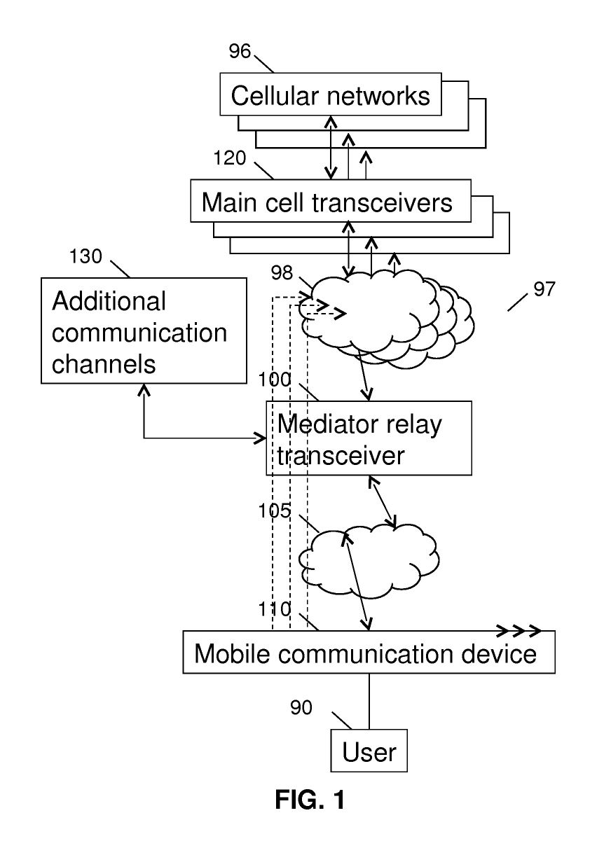

FIG. 1 is a block diagram illustrating a communication system for reducing cellular radiation intensity near users, according to some embodiments of the invention. The communication system comprises mobile communication device 110 associated with users 90 and at least one mediator relay transceiver 100. Mobile communication device 110 exhibit short range communication capabilities as well as cellular communication capabilities. Mediator relay transceiver 100 is arranged to connect via an internal communication link 105 to mobile communication devices 110 and to connect via cellular communication links 98 to main cell transceivers 120 connected to cellular networks 96. Internal communication link 105 utilizes the short range communication capabilities of mobile communication devices 110 and replaces user communication 97 via cellular communication link 98 to main cell transceivers 120. Instead, users 110 communicate via internal communication link 105 with mediator relay transceiver 100 which is arranged to transmit and receive user communication between mobile communication devices 110 and main cell transceivers 120. Mediator relay transceiver 100 communicates with main cell transceivers 120 via their respective cellular communication links 98, yet by communicating with users 90 via internal communication link 105 mediator relay transceiver 100 reduces the radiation in the vicinity of users 90 emitted by mobile communication devices 110. Internal communication link 105 may exhibit radio frequency radiation that is harmless to the human body (e.g. operating in an appropriate intensity, frequency range, modulation method). Mediator relay transceiver 100 is arranged such that the radiation to users 90 via internal communication link 105 is of lower intensity than the radiation to users 90 via cellular communication link 98 (i.e. prior art communication 97).

According to some embodiments of the invention, mediator relay transceiver 100 may be arranged to substantially immediately select a communication channel from cellular communication link 98 and additional communication channels 130, such that the selected communication channel optimizes communication parameters relating to user 90 and to mediator relay transceiver 100. For example, mediator relay transceiver 100 may optimize the price paid by user 90 to different providers (route communication to the cheapest provider), optimize the load on mediator relay transceiver 100 or on cellular communication link 98 or additional communication channels 130, minimize the level of radiation emitted from mediator relay transceiver 100 (e.g. reducing cellular communication), or optimize communication relating to some of these factors or other related factors and parameters. Optimization may be carried out in real time, i.e. relating to changing conditions of communications, user preferences, user in the system and so forth.

According to some embodiments of the invention, internal communication link 105 may be a low intensity communication link such as Bluetooth or WiFi. Internal communication link 105 may exhibit radio frequency radiation that is harmless to the human body (e.g. operating in an appropriate intensity, frequency range, modulation method). Internal communication link 105 may be further characterized by an appropriate modulation method, harmless frequencies and so on. Mediator relay transceiver 100 may be further connected to at least one additional communication channel 130 such as wire communication, internet communication (e.g. communication over IP) or other cellular networks. Mediator relay transceiver 100 may be arranged to route communication relating to additional communication channels 130 it is connected to.

Mediator relay transceiver 100 may be located outdoors and be constructed to endure external conditions. Mediator relay transceiver 100 may be located indoors and be design accordingly. Mediator relay transceiver 100 complies to the prevailing standards relating to radiation intensity in both internal communication link 105 and cellular communication link 98.

According to some embodiments of the invention, communication between mediator relay transceiver 100 and users 90 may be encrypted. According to some embodiments, mobile communication device 110 is arranged to indicate communication via internal communication link 105. For example, a “Low Radiation” notice may be displayed on mobile communication device 110. According to some embodiments, mobile communication device 110 may be disabled to communicate via cellular networks 96 while communicating via mediator relay transceiver 100, thus assuring all communication is characterized by low radiation, an no environmental radiation is produced. According to some embodiments, mobile communication device 110 may be arranged to allow user definition of operating uniquely via internal communication link 105. So, user 90 may avoid using cellular networks 96 when internal network 105 is available, or avoid using cellular networks 96 permanently.

According to some embodiments of the invention, mediator relay transceiver 100 may comprise a prioritization module, that may favor some of users 90 over other users 90 in relation to their affiliation to different groups, such as guests of a hotel, members of an organization, private customers and so forth.

According to some embodiments of the invention, mediator relay transceiver 100 may be arranged to detect and identify mobile communication devices 110 within a predefined range and communicate with identified communication devices via internal communication link 105. Mediator relay transceiver 100 may have a maximal number of communication devices 110 that it can handle via internal communication link 105. Surplus communication devices may be either handed to an adjacent mediator relay transceiver 100 or ignored by mediator relay transceiver 100 and be left to communicate via main cell transceiver 120 as before. Mediator relay transceiver 100 may communicate with surplus communication devices after other communication devices have exited the predefined range.

According to some embodiments of the invention, mediator relay transceiver 100 may be arranged to identify mobile communication devices 110 leaving internal communication link 105 and to allow the identified mobile communication devices 110 to communicate with cellular network 96 according to predefined user preferences. This way mediator relay transceiver 100 keeps continuous communication to mobile communication devices 110 upon exiting the range of internal communication link 105.

According to some embodiments of the invention, the communication system may be used to serve private homes, offices, public places such as hotels, malls, restaurants etc.

According to some embodiments of the invention, mediator relay transceiver 100 may be further utilized to send predefined content to user 90 via internal communication link 105. Such content may comprise e.g. offers and coupons to hotel guests. The predefined content may further comprise commercials or ads relating to different service providers and suppliers. The predefined content may relate to the location of mediator relay transceiver 100, data of preferences of users 90 or other factors.

According to some embodiments of the invention, mediator relay transceiver 100 may be the only possibility for user 90 to communicate via mobile communication device 110 when in range.

An indication of the communication being only via mediator relay transceiver 100 may be presented on mobile communication device 110 such as a message “Low radiation” on the display of mobile communication device 110. Disconnecting from mediator relay transceiver 100 allows user 90 to return to communicate via cellular communication link 98. According to some embodiments of the invention, user 90 may be allowed to define the operation of mobile communication device 110 as being solely via mediator relay transceiver 100, i.e. mobile communication device 110 does not operate or is not able to communicate when out of range of mediator relay transceiver 100. According to some embodiments of the invention, user 90 may be allowed to define the operation of mobile communication device 110 as being either via cellular network 96 or via another mediator relay transceiver (such as one relating to a different location, or an adjacent mediator relay transceiver).

According to some embodiments of the invention, the communication system may be arranged to enable users 90 to switch from one mediator relay transceiver 100 to an adjacent mediator relay transceiver 100 while retaining communication.

According to some embodiments of the invention, mediator relay transceiver 100 may be easy to maintain and operate automatically. Mediator relay transceiver 100 may comprise a display arranged to display the status of mediator relay transceiver 100 and a backup battery.

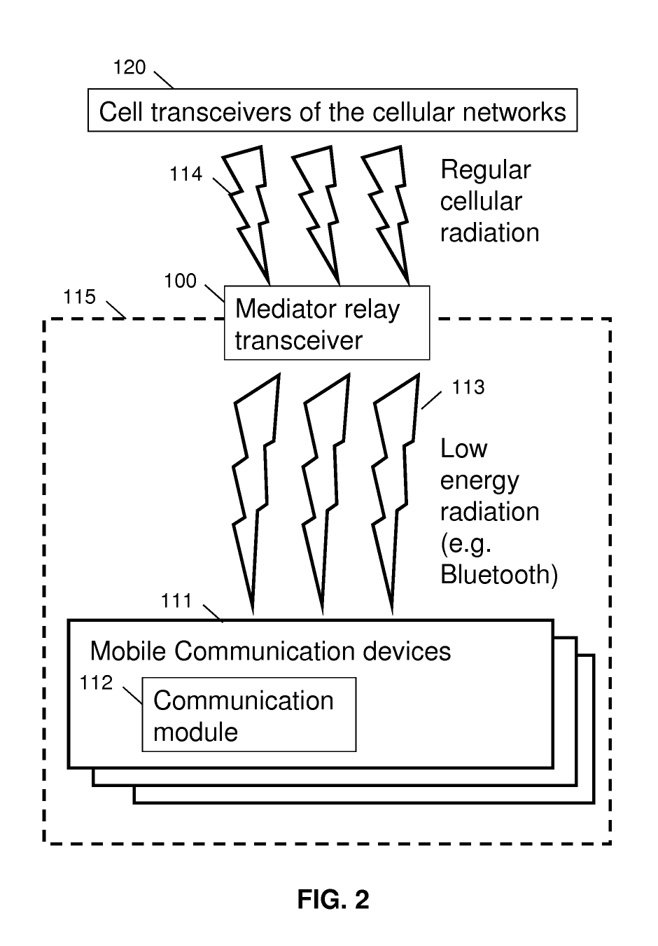

FIG. 2 is a block diagram illustrating a communication system for reducing cellular radiation intensity near users using cellular networks, according to some embodiments of the invention. The communication system comprises mediator relay transceiver 100 connected to users' mobile communication devices 111 and to cell transceivers 120 of the cellular networks. While the connection to cell transceivers 120 is via cellular communication with its regular radiation levels 114, the connection to mobile communication devices 111 is via a communication link characterized by a low energy radiation 113, such as radio frequency·e.g. Bluetooth. Mediator relay transceiver 100 thus creates around users an area 115 with reduced cellular radiation, as mobile communication devices 111 in area 115 use only the low energy radiation 113 to communicate with mediator relay transceiver 100. Mediator relay transceiver 100 stays transparent to the users as their communication proceeds to be via their cellular network.

According to some embodiments of the invention, mobile communication devices 111 may be adapted to communicate with mediator relay transceiver 100. Either a built-in short range communication may be utilized to communicate with mediator relay transceiver 100, or a communication module 112 may be added to each mobile communication devices 111 that enables the necessary communication.

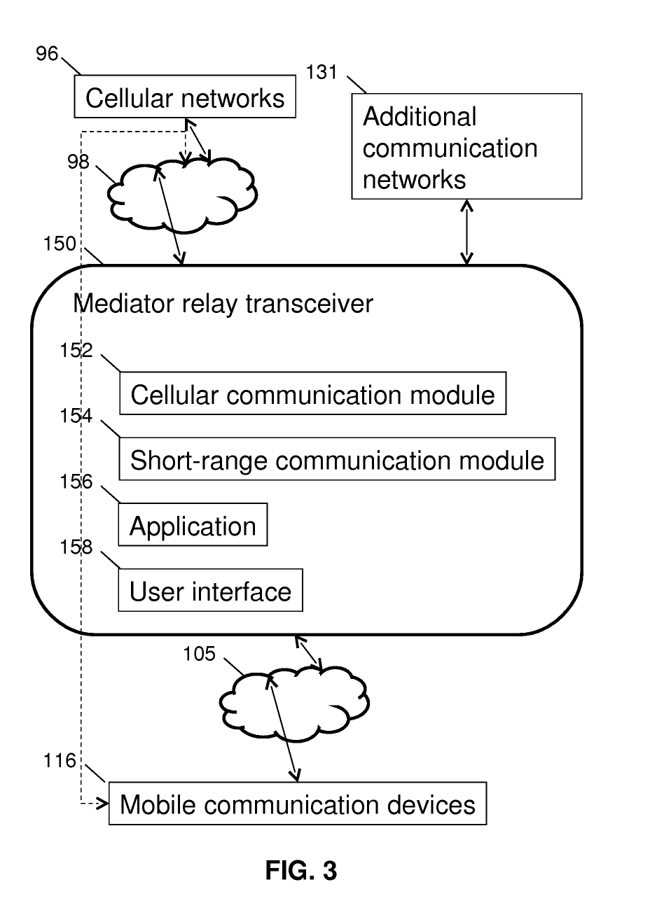

FIG. 3 is a block diagram illustrating a mediator relay transceiver 150 for reducing cellular radiation intensity near users using cellular networks 96, according to some embodiments of the invention. Mediator relay transceiver 150 comprises a cellular communication module 152, a short-range communication module 154, a user interface 156 and an application 156. Cellular communication module 152 exhibits cellular communication capabilities and is connected via cellular communication links 98 to cellular networks 96. Short-range communication module 154 exhibits short range communication capabilities and is connected via internal communication link 105 to communication devices 116 that are associated with the users. Mobile communication devices 116 exhibit short range communication capabilities as well as cellular communication capabilities. User interface 158 is arranged to present a status of mediator relay transceiver 150 and to enable inputting preferences relating to the operation of mediator relay transceiver 150. Application 156 is arranged to control the operation of cellular communication module 152, short-range communication module 154 and user interface 158, coordinate among them, route all communication correctly and report to managing services. Application 156 may further control user roaming among mediator relay transceivers 150, and manage the number of mobile communication devices communicating via mediator relay transceiver 150.

Mediator relay transceiver 150 may be arranged to transmit and receive communication between mobile communication devices 116 and cellular networks 96, possibly also additional communication networks 131 (e.g. wire communication). According to some embodiments of the invention, mediator relay transceiver 150 may be arranged to substantially immediately select a communication channel from cellular communication link 98 and additional communication channels 131, such that the selected communication channel optimizes communication parameters relating to the user and to mediator relay transceiver 150. For example, mediator relay transceiver 150 may optimize the price paid by the user to different providers (route communication to the cheapest provider), optimize the load on mediator relay transceiver 150 or on cellular communication link 98 or additional communication channels 131, minimize the level of radiation emitted from mediator relay transceiver 150 (e.g. reducing cellular communication), or optimize communication relating to some of these factors or other related factors and parameters. Optimization may be carried out in real time, i.e. relating to changing conditions of communications, user preferences, user in the system and so forth.

In effect, mediator relay transceiver 150 is connected via internal communication link 105 to users' communication devices 116 and connected via cellular communication links 98 to cellular networks 96. Thus, short-range communication via internal communication link 105 replaces for the users the prior art direct communication via cellular communication links 98 (broken line). Internal communication link 105 utilizes the short range communication capabilities exhibited by mobile communication devices 116 and user communication via internal communication link 105 replaces user communication (broken line) via cellular communication links 98 to cellular networks 96. Mediator relay transceiver 150 is arranged such that the radiation to users via internal communication link 105 is of lower intensity than the radiation to users via cellular communication links 98 in prior art (broken line).

According to some embodiments of the invention, internal communication link 105 may comprise a low intensity communication link such as Bluetooth. Internal communication link 105 may exhibit radio frequency radiation that is harmless to the human body (e.g. operating in an appropriate intensity, frequency range, modulation method). Mediator relay transceiver 150 may be located outdoors and constructed to endure external conditions, or be located indoors.

Mediator relay transceiver 150 may be further arranged to detect and identify mobile communication devices 116 within a predefined range and communicate with identified communication devices via internal communication link 105. Mediator relay transceiver 150 may be arranged to identify mobile communication devices 116 leaving internal communication link 105 and to allow the identified mobile communication devices 116 to communicate with cellular network 96 according to predefined user preferences. This way mediator relay transceiver 150 keeps continuous communication to mobile communication devices 116 upon exiting the range of internal communication link 105. Mediator relay transceiver 150 may be further utilized to send predefined content to users via internal communication link 105. Mediator relay transceiver 150 may further comprise a backup battery. Internal communication link 105 may be encrypted and secure.

Mediator relay transceiver 150 may be further arranged to enable users communicate among themselves via internal communication link 105 without using cellular communication link 98.

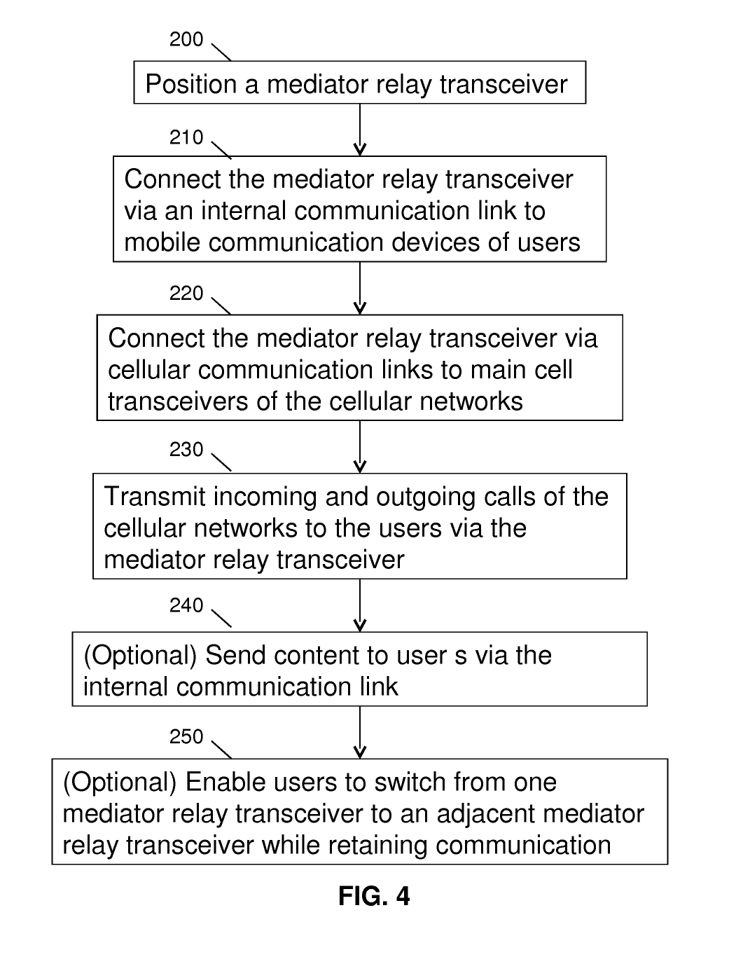

FIG. 4 is a flowchart illustrating a method of reducing cellular radiation intensity near at least one user using a cellular network, according to some embodiments of the invention. The method comprises the stages: Positioning at least one mediator relay transceiver (stage 200); connecting the at least one mediator relay transceiver via an internal communication link to at least one mobile communication device of the at least one user (stage 210); connecting the at least one mediator relay transceiver via a cellular communication link to at least one main cell transceiver of the cellular network (stage 220); and transmitting incoming and outgoing calls of the cellular network to the at least one user via the at least one mediator relay transceiver (stage 230).

According to some embodiments of the invention, positioning at least one mediator relay transceiver (stage 200) is carried out such that the radiation to the user via the internal communication link is of lower intensity than the radiation to the user via the cellular communication link. According to some embodiments of the invention, the internal communication link 105 may exhibit radio frequency radiation that is harmless to the human body (e.g. operating in an appropriate intensity, frequency range, modulation method).

According to some embodiments of the invention, the method may further comprise at least one of the stages: Sending predefined content to the at least one user via the internal communication link (stage 240); and enabling users to switch from one mediator relay transceiver to an adjacent mediator relay transceiver while retaining communication (stage 250).

According to some embodiments of the invention, the method may further comprise prioritizing the users in relation to different user affiliations, such as guests of a hotel, members of an organization, private customers and so forth.

According to some embodiments of the invention, the method may further comprise enabling users to communicate with other users via the internal communication link, and without having to use the cellular communication link and cellular network.

According to some embodiments of the invention, the method may transmit incoming and outgoing calls of the cellular networks to the users via the mediator relay transceiver (stage 230) in an encrypted and secure manner. According to some embodiments of the invention, the method may be transparent to the users in the sense that they use their mobile communication devices in the same way when communication is transmitted via internal communication link (stage 230) as they do when communication is via their cellular network.

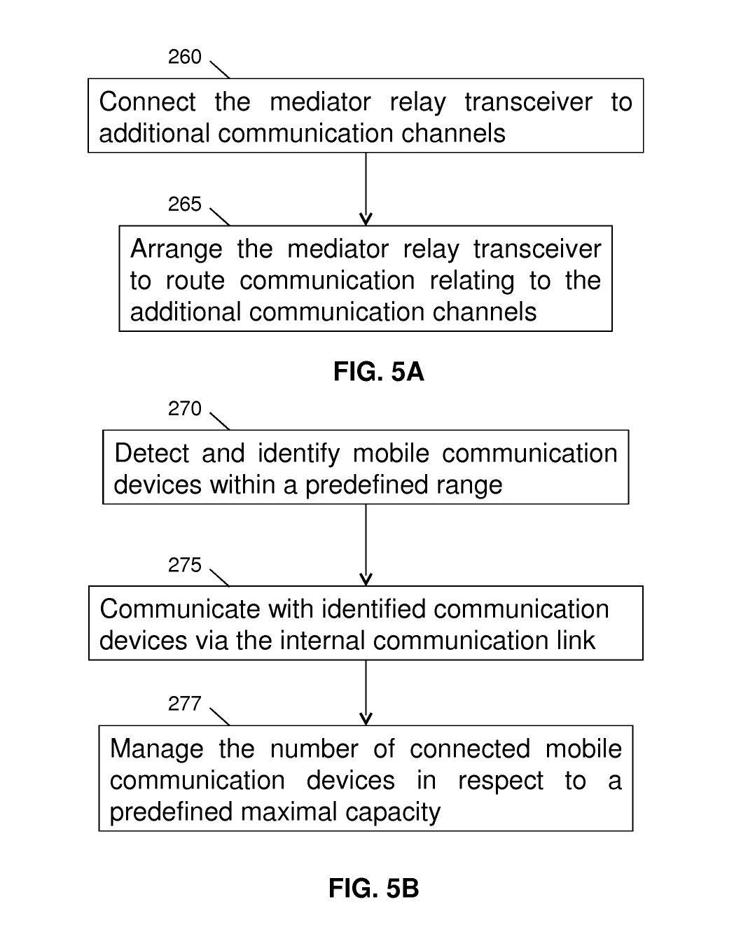

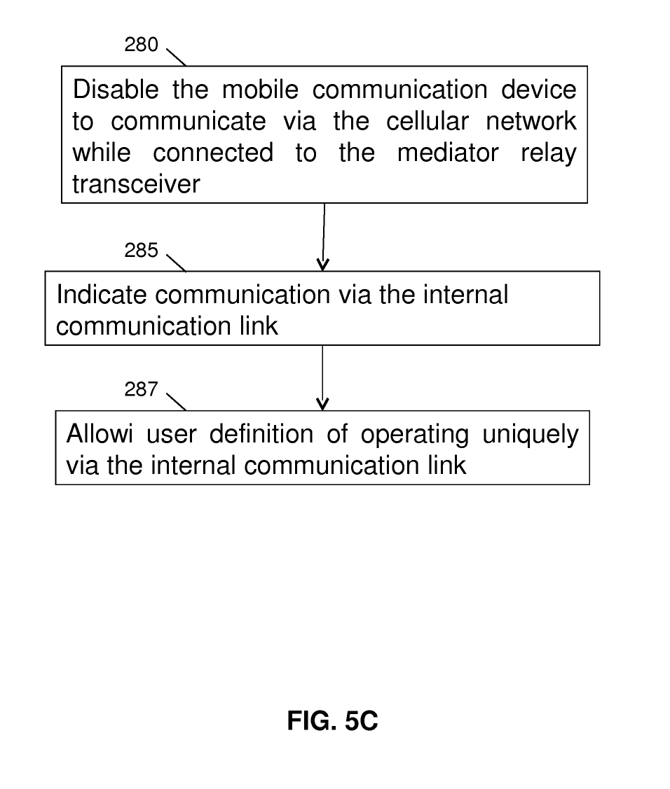

FIGS. 5A, 5B and 5C are flowcharts illustrating additional stages of the method of reducing cellular radiation intensity, according to some embodiments of the invention. the method may further comprise at least one of the stages (FIG. 5A): Connecting the at least one mediator relay transceiver to at least one additional communication channel (stage 260); and arranging the at least one mediator relay transceiver to route communication relating to the at least one additional communication channel (stage 265).

According to some embodiments of the invention, routing communication (stage 265) may further comprise substantially immediately selecting a communication channel from either cellular communication link or additional communication channel, such that the selected communication channel optimizes communication parameters. The communication parameters may relate to either users or mediator relay transceiver. Examples for this optimization may comprise optimizing the price paid by the user to different providers (route communication to the cheapest provider), optimizing the load on the mediator relay transceiver or on the cellular communication link or additional communication channels, minimizing the level of radiation emitted from mediator relay transceiver (e.g. reducing cellular communication), or optimizing communication relating to some of these factors or other related factors and parameters. Optimization may be carried out in real time, i.e. relating to changing conditions of communications, user preferences, user in the system and so forth.

According to some embodiments of the invention (FIG. 5B), the method may further comprise at least one of the stages: Detecting and identifying mobile communication devices within a predefined range (stage 270); communicating with identified communication devices via the internal communication link (stage 275); and managing the number of connected at least one mobile communication device in respect to a predefined maximal capacity (stage 277).

According to some embodiments of the invention, detecting and identifying mobile communication devices within a predefined range (stage 270) may further comprise identifying mobile communication devices leaving the internal communication link and allowing the identified mobile communication devices to communicate with the cellular network.

According to some embodiments of the invention (FIG. 5C), the method may further comprise at least one of the stages: disabling the mobile communication device to communicate via cellular network (stage 280) while transmitting incoming and outgoing calls of the cellular network to the user via the mediator relay transceiver (stage 230); indicating communication via the internal communication link (stage 285) e.g. by presenting a “Low Radiation” notice on the display of the communication device; and allowing user definition of operating uniquely via the internal communication link (stage 287) while possible, i.e. “locking” the communication device to cellular networks and channeling all communication via the internal network.

According to some embodiments of the invention, the method and communication system for reducing cellular radiation intensity near users using a cellular network may be utilized to define areas or spaces and keep them free of cellular radiation by connecting all cellular users to the system. Persons in these areas or spaces are not subject to “passive” cellular radiation, i.e. radiation from other cellular users. The communication system may be connected to existing communication networks such as telecom and Skype, as well as to other appliances such as storage devices, computers etc.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention can be implemented in the testing or practice with methods and materials equivalent or similar to those described herein.

While the invention has been described with respect to a limited number of embodiments, these should not be construed as limitations on the scope of the invention, but rather as exemplifications of some of the preferred embodiments. Those skilled in the art will envision other possible variations, modifications, and applications that are also within the scope of the invention. Accordingly, the scope of the invention should not be limited by what has thus far been described, but by the appended claims and their legal equivalents.

What is claimed is:

1. A communication system for reducing cellular radiation intensity near users, the communication system comprising:
at least one mobile communication device associated with at least one user and exhibiting short range communication capabilities as well as cellular communication capabilities; and
at least one mediator relay transceiver, arranged to connect via an internal communication link to at least one mobile communication device and to connect via at least one cellular communication link to at least one main cell transceiver,
wherein the at least one main cell transceiver is connected to at least one cellular network;
wherein the internal communication link utilizes the short range communication capabilities exhibited by the at least one mobile communication device;
wherein the at least one mediator relay transceiver is connected to each of the at least one main cell transceiver via at least one corresponding cellular communication link;
wherein the at least one mediator relay transceiver is arranged to transmit and receive communication between the at least one mobile communication device and the at least one main cell transceiver;
wherein user communication via the internal communication link replaces user communication via the at least one cellular communication link to the at least one main cell transceiver; and
wherein the at least one mediator relay transceiver is arranged such that the radiation to the at least one user via the internal communication link is of lower intensity than the radiation to the at least one user via the at least one cellular communication link.

2. The communication system of claim 1, wherein the internal communication link exhibits radio frequency radiation that is harmless to the human body.

3. The communication system of claim 1, wherein the at least one mediator relay transceiver is further connected to at least one additional communication channel.

4. The communication system of claim 3, wherein the at least one mediator relay transceiver is arranged to route communication relating to the at least one additional communication channel.

5. The communication system of claim 4, wherein the at least one mediator relay transceiver is arranged to substantially immediately select a communication channel from said at least one cellular communication link and said at least one additional communication channel, such that the selected communication channel optimizes communication parameters relating to the at least one user and to the at least one mediator relay transceiver.

6. A mediator relay transceiver comprising:
a cellular communication module exhibiting cellular communication capabilities and connected via at least one cellular communication link to at least one cellular network;
a short-range communication module exhibiting short range communication capabilities and connected via an internal communication link to at least one mobile communication device associated with at least one user, wherein the at least one mobile communication device exhibits short range communication capabilities as well as cellular communication capabilities;
a user interface arranged to present a status of the mediator relay transceiver and to enable inputting preferences; and
an application arranged to control the operation of the cellular communication module, the short-range communication module and the user interface,
wherein the at least one mediator relay transceiver is arranged to transmit and receive communication between the at least one mobile communication device and the at least one cellular network;
wherein the internal communication link utilizes the short range communication capabilities exhibited by the at least one mobile communication device;
wherein user communication via the internal communication link replaces user communication via the at least one cellular communication link to the at least one cellular network; and
wherein the at least one mediator relay transceiver is arranged such that the radiation to the at least one user via the internal communication link is of lower intensity than the radiation to the at least one user via the at least one cellular communication link.

7. The mediator relay transceiver of claim 6, wherein the internal communication link exhibits radio frequency radiation that is harmless to the human body.

8. The mediator relay transceiver of claim 6, further connected to at least one additional communication network.

9. The mediator relay transceiver of claim 8, further arranged to route communication relating to the at least one additional communication channel.

10. The mediator relay transceiver of claim 9, further arranged to substantially immediately select a communication channel from said at least one cellular communication link and said at least one additional communication channel, such that the selected communication channel optimizes communication parameters relating to the at least one user and to the at least one mediator relay transceiver.

11. The mediator relay transceiver of claim 6, located outdoors and constructed to endure external conditions.

12. The mediator relay transceiver of claim 6, located indoors.

13. A method of reducing cellular radiation intensity near users, the method comprising:
positioning at least one mediator relay transceiver;
connecting the at least one mediator relay transceiver via an internal communication link to at least one mobile communication device of at least one user;
connecting the at least one mediator relay transceiver via at least one cellular communication link to at least one main cell transceiver of at least one cellular network; and
transmitting incoming and outgoing calls of the cellular network to the at least one user via the at least one mediator relay transceiver,
wherein said positioning at least one mediator relay transceiver is carried out such that the radiation to the user via the internal communication link is of lower intensity than the radiation to the user via the cellular communication link.

14. The method of claim 13, further comprising disabling the at least one mobile communication device to communicate via the at least one cellular network while said transmitting incoming and outgoing calls of the cellular network to the at least one user via the at least one mediator relay transceiver.

15. The method of claim 13, further comprising indicating communication via the internal communication link.

16. The method of claim 13, further comprising allowing user definition of operating uniquely via the internal communication link.

17. The method of claim 13, wherein the internal communication link exhibits radio frequency radiation that is harmless to the human body.

18. The method of claim 13, further comprising connecting the at least one mediator relay transceiver to at least one additional communication channel.

19. The method of claim 18, further comprising arranging the at least one mediator relay transceiver to route communication relating to the at least one additional communication channel.

20. The method of claim 19, further comprising substantially immediately selecting a communication channel from said at least one cellular communication link and said at least one additional communication channel, such that the selected communication channel optimizes communication parameters relating to the at least one user and to the at least one mediator relay transceiver.
